(19) United States
(12) Patent Application Publication
(10) Pub. No.: US 2011/0292013 A1
(43) Pub. Date: Dec. 1, 2011

(54) ELECTRONIC BOOK

(75) Inventors: YU-HUA WU, Shenzhen City (CN); MING-CHANG LEE, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 12/823,307

(22) Filed: Jun. 25, 2010

(30) Foreign Application Priority Data
Jun. 1, 2010 (CN) 201010189529.4

(51) Int. Cl. G09G 3/34; G06F 3/038; F21V 33/00

(52) U.S. Cl. 345/211; 362/253; 345/107

(57) ABSTRACT

An electronic book includes a main body and an attached flexible hose lamp.

### BACKGROUND

1. Technical Field

The present disclosure relates to an electronic book.

2. Description of Related Art

Due to small size, light weight, and ease of storage, electronic books are widely used. A conventional electronic book includes an electrophoretic display (EPD). However, the electrophoretic display is only visible when externally lit.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an assembled, isometric view of an exemplary embodiment of an electronic book.

FIG. 2 shows a use state of the electronic book of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

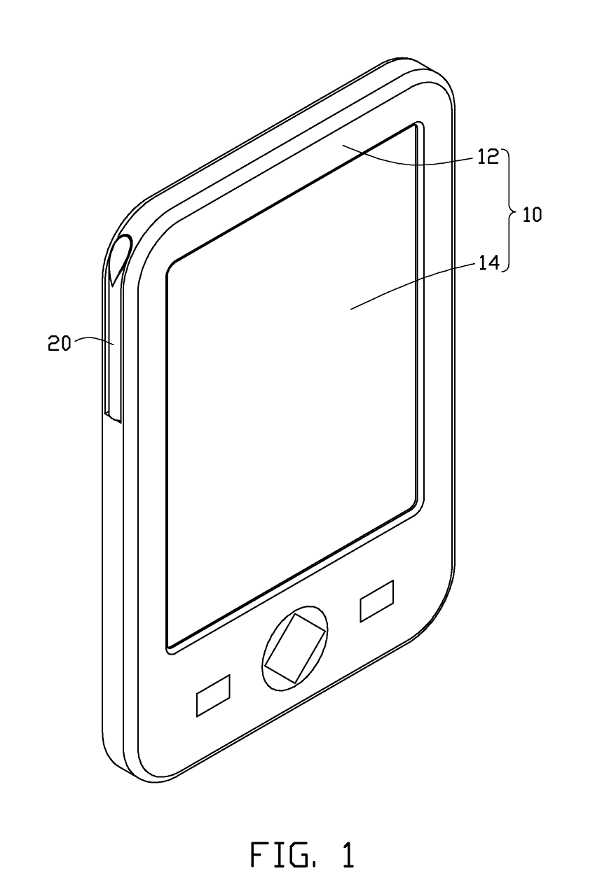

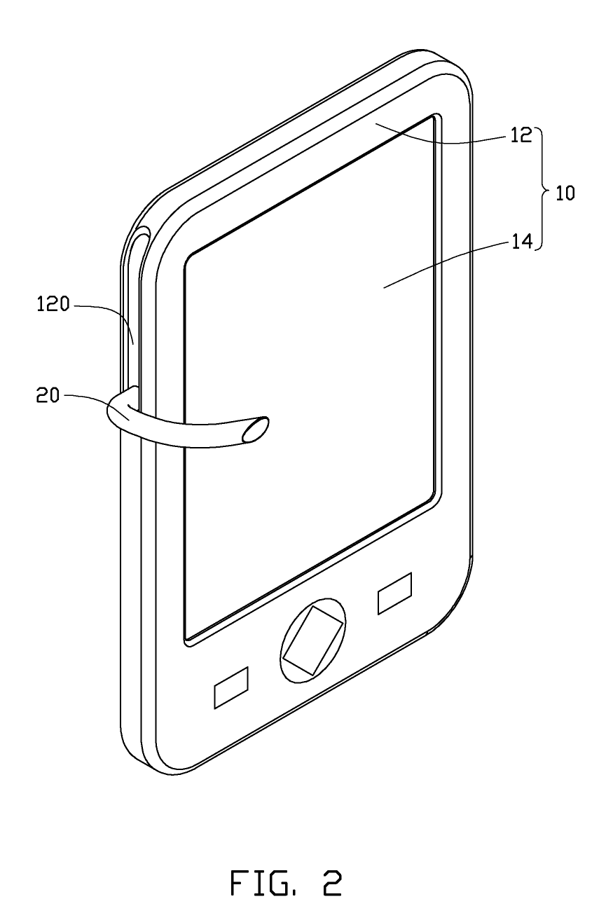

Referring to FIGS. 1 and 2, an exemplary embodiment of an electronic book includes a main body 10 and a flexible hose lamp 20. The hose lamp 20 is movably mounted to the main body 10 and electrically connected to electronic elements in the main body 10. In this embodiment, the main body 10 includes a switch (not shown) to turn on or turn off the hose lamp 20.

The main body 10 is as an ordinary electronic book, and includes a shell 12 and an electrophoretic display (EPD) 14 installed in a top of the shell 12. A first sidewall of the shell 12 defines a receiving space 120.

The hose lamp 20 is a common light emitting diode hose lamp, and can be bent freely. The hose lamp 20 is received in the receiving space 120.

When the electronic book is used in darkness, the hose lamp 20 is partly drawn out of the receiving space 120 and bent to a effective position to shine light on the EPD 14. The hose lamp 20 is turned on to light the EPD 14.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An electronic book comprising:
a main body; and
a flexible hose lamp with an end installed to the main body.

2. The electronic book of claim 1, wherein the hose lamp is a light emitting diode hose lamp.

3. The electronic book of claim 1, wherein the main body includes a shell and an electrophoretic display installed in a top of the shell, a sidewall of the shell defines a receiving space to receive the hose lamp.

4. The electronic book of claim 3, wherein the hose lamp is operable to be bent to an effective position above the electrophoretic display to light on the electrophoretic display.

5. The electronic book of claim 1, wherein the hose lamp is electrically connected to the main body.
